(19) United States
(12) Patent Application Publication
(10) Pub. No.: US 2009/0104958 A1
(43) Pub. Date: Apr. 23, 2009

(54) Video poker game providing a bonus advantage for every win

(75) Inventor: Kathleen Nylund Jackson, Scituate, MA (US)

Correspondence Address: Precedent Gaming, Inc., 51 Williamsburg Lane, Scituate, MA, 02066, US

(73) Assignee: Precedent Gaming, Incorporated

(21) Appl. No.: 12/288,796

(22) Filed: Oct. 23, 2008

Related U.S. Application Data
(60) Provisional application No. 60/999,963, filed on Oct. 23, 2007.

(51) Int. Cl. A63F 9/24; A63F 13/00

(52) U.S. Cl. 463/13

(57) ABSTRACT

A video monitor screen is provided on which symbol-bearing playing cards may be provided for use in a video poker game. The player makes a wager to play a first underlying game. A predetermined number of playing cards are initially displayed, and the player is prompted to hold none, one, some or all of the cards. Unheld cards are discarded and replaced by replacement cards to form a final hand. The symbols in the final hand provide an outcome, and the outcome is analyzed for predetermined winning symbol combinations that are paid according to a predetermined paytable. If the outcome includes any winning symbol combinations, regardless of the make-up or rank of the winning symbol combinations, a bonus opportunity or event is provided in the next game.

### RELATED APPLICATION DATA

This Application claims priority from U.S. Provisional Patent Application No. 60/999,963, filed Oct. 23, 2007, and having the Title VIDEO POKER GAME PROVIDING A BONUS ADVANTAGE FOR EVERY WIN.

### BACKGROUND OF THE INVENTION

1. Field of the Invention

The present invention relates to an electronic poker game suitable for use in casinos and other gaming enterprises. The invention further relates to video gaming play that provides a bonus event opportunity for every winning outcome, regardless of the make-up or rank of the winning outcome, thereby increasing the chance of winning and/or the chance of larger wins.

2. Background of the Art

Gaming machines, whether providing video poker or slot games, have grown exponentially in numbers in the last twenty years, as have the revenues generated by such devices. It is estimated that more than 75% of any casino's revenue is now provided by gaming machines as opposed to table games.

Especially in the last decade, basic video poker games have been augmented by bonus features or games that are particularly popular with the gaming public. In some cases, a “triggering” event during the primary game awards the player with special feature opportunities. Most often the special features can provide players with more lucrative awards as compared to the primary game, and for this reason, many players will continue to play the primary game mainly for the chance of playing the special feature.

Certain prior art has attempted to enhance the known video poker gameplay by including special cards or symbols, multipliers and/or free hands. Other innovations include a triggering mechanism that allows for the play of a feature event. Still other new methods offer an additional side bet that provides the opportunity to receive enhanced gameplay features that can provide the player with heftier payouts.

U.S. Pat. Nos. 7,156,397 and 6,419,578 (Moody, et al.) disclose video poker game play that provides various bonus features on initially dealt hands. The bonuses are provided if the player's starting hand of cards has a poker hand ranking of any preselected combination of cards.

U.S. Pat. No. 6,110,040 (Sanduski, et al.) describes a video poker gaming machine where, after initially dealing five cards to a player, the machine displays a sixth card to replace a discarded card by the player. In one embodiment, the sixth card automatically replaces the leftmost discarded card. In another embodiment, the sixth card can replace any of the discarded cards.

United States Patent Application Number 20070032284 (Englman) teaches a method of conducting a wagering game on a gaming machine that includes the steps of receiving an initial wager from a player and dealing a set of initial game elements. The player is provided with an option to purchase an additional game element. In response to player input, none or more of the initial game elements are replaced with respective replacement game elements and, if the player exercised the option, the method also includes dealing the additional game element to form a set of final game elements. The method further includes a step of evaluating the final set of game elements relative to an award schedule.

United States Patent Application Number 20060246978 (Gallagher) describes various embodiments of a method for playing a card game in association with a poker-style card game. The method includes dealing at least one additional card at a normal ending point of the poker-style card game in response to placement of a supplemental bet and factoring the additional card into the outcome of the poker-style card game. In addition to offering payouts for hands achieved by consideration of various five-card combinations, payouts may also be awarded for “premium” hands that combine six or more cards. Examples of premium six-card hand combinations that may receive payouts include six-card straights and flushes, six-card straight flushes, four-of-a-kind and a pair, two threes-of-a-kind, and three pair.

United States Patent Application Number 20060199632 (Thomas, et al.) discloses a card-based wagering game that provides randomly selected outcomes including a plurality of winning hands that range from a lowest winning hand to a highest winning hand and a plurality of qualifying hands such that the qualifying hand is greater than the lowest winning hand. In response to the randomly selected outcome being the qualifying-hand outcome, the gaming machine awards a player a bonus hand.

United States Patent Application Number 20050026665 (Gerrard, et al.) discloses a gaming device having a poker game with multiple options for the player to purchase extra cards in order to improve the chance of winning.

United States Patent Application Number 20040043807 (Pennington) describes a poker game having a second chance feature. A player is allowed to replay a hand of cards in a poker game when the hand of cards includes a triggering hand.

It is an objective of the present invention to improve on the prior art and provide players with new and enticing features that will stimulate player interest and increase time on the machine. In particular, the present invention seeks to provide the player with a dynamic gameplay that will heighten the player's expectations by providing a bonus feature for every winning outcome. In particular, the availability of the bonus feature is not based on any particular criterium of the winning outcome, but is provided for any and all wins. The bonus feature may increase the possibility and/or profitability of winning events, preferably without reducing the underlying paytable.

### SUMMARY OF THE INVENTION

A processor-controlled video monitor screen is provided on which symbol-bearing elements may be provided for use in a video poker game. The player makes a wager to play a first underlying game. A predetermined number of symbol-bearing playing cards are initially dealt and displayed face up, and the player is prompted to hold none, one, some or all of the cards. Unheld cards or discard cards are discarded and replaced by replacement cards, the final hand consisting of any and all held cards plus any and all replacement cards. The symbols in the final hand provide an outcome, and the outcome is analyzed for predetermined winning symbol combinations, any winning symbol combinations being paid according to a predetermined paytable. If the outcome includes a winning symbol combination, a bonus event is provided in the next (second) wagered game. The provision of the bonus event, in this case and in all subsequent cases of the present invention, is not based on a particular criterium of the winning outcome, but rather is a guaranteed feature after any and all wins. Preferably the bonus event consists of at least one additional card being added to the predetermined number of cards being dealt in the first underlying game (although other bonus events are contemplated, including free hands, multipliers, wild cards, alternate pays and the like). The second game is played according to the aforementioned specifications in the first game, with the player choosing to hold none, one, some or all of the initially dealt cards; replacing the unheld cards with replacement cards; a final hand being formed by the held cards and the replacement cards; the symbols in the final hand providing an outcome; the outcome being analyzed for winning symbol combinations; and any winning symbol combinations being paid according to a predetermined paytable and preferably the same paytable as in the first game. If the outcome includes a winning symbol combination, a bonus event is provided in the next (third) wagered game. The bonus event preferably consists of at least one additional card being added to the predetermined number of cards being dealt as in the first underlying game or as in the second game. This third game is played according to the aforementioned specifications in the first game and with any winning symbol combinations being paid according to a predetermined paytable and preferably the same paytable as in the first game. If the outcome of any game is a non-winning outcome, the predetermined number of cards in the next game is the same as the predetermined number of cards in the first underlying game.

### BRIEF DESCRIPTION OF THE FIGURES

FIG. 1 shows a monitor screen of a video poker machine with the results of a first deal.

FIG. 2 shows the same game at a later stage.

FIG. 3 shows the same game at a final stage.

FIG. 4 shows a monitor screen of a video poker machine with the results of a second deal.

FIG. 5 shows the same game at a later stage.

FIG. 6 shows the same game at a final stage.

FIG. 7 shows a monitor screen of a video poker machine with the results of a third deal.

FIG. 8 shows the same game at a later stage.

FIG. 9 shows the same game at a final stage.

FIG. 10 shows a monitor screen of a video poker machine with the results of a fourth deal.

FIG. 11 shows the same game at a later stage.

FIG. 12 shows the same game at a final stage.

FIG. 13 shows a monitor screen of a video poker machine with the results of a fifth deal.

### DETAILED DESCRIPTION OF THE INVENTION

A processor and video monitor screen are provided on which symbol-bearing elements may be provided for use in a video poker game. The symbol-bearing elements are preferably virtual playing cards displayed in a single row. A single virtual deck of 52 cards (although more cards may be utilized if jokers, wild cards or special cards are added to the deck) is provided for the play of the video poker game.

The player makes a wager to play a first underlying game. Preferably an additional wager or “side bet” is not required to play the underlying game or any subsequent games. Upon making the game wager, a first array of symbol-bearing cards is dealt and displayed face up on the monitor screen. Preferably the initial array consists of six cards, with the eventual outcome of the first underlying game being determined by the best-5-out-of-6 cards. The player may then choose to hold none, one, up to all of the dealt cards. Unheld cards are discarded and replacement cards are provided for the discards to form a final 6-card hand. The symbol-bearing cards in the final hand provide an outcome, the outcome is analyzed by the processor, and any winning combinations based on the best-5-out-of-6 cards in the final hand are paid according to a predetermined paytable. If the outcome includes a winning symbol combination, therefore being a winning outcome, a bonus event will be provided in the next game, specifically the next game being a second wagered game. The provision of the bonus event, in this case and in all subsequent cases of the present invention, is not based on a particular criterium of the winning outcome, but rather is a guaranteed feature after any and all wins. The bonus event consists of at least one, and preferably exactly one, additional card being added to the predetermined number of cards being dealt as in the first underlying game, or specifically seven cards. The second game is played according to the basic specifications in the first game (with the exception of any winning combinations being now based on the best-5-out-of-7 cards), with the player choosing to hold none, one, some or all of the initially dealt cards; replacing the unheld cards with replacement cards; a final hand being formed by the held cards and the replacement cards; the symbols in the final hand providing an outcome; the outcome being analyzed for winning symbol combinations; and any winning symbol combinations being paid according to a predetermined paytable and preferably the same paytable as in the first game. If the outcome includes a winning symbol combination, a bonus event is provided in the next game, specifically a third wagered game. The bonus event in the third game consists of at least one, and preferably exactly one, additional card being added to the predetermined number of cards being dealt as in the first underlying game or alternately as in the second game, i.e., seven cards or alternately eight cards are provided in the initially dealt array of cards. This third game is played according to the specifications in the first game (with the exception of any winning combinations being now based on the best-5-out-of-7 cards or alternately the best-5-out-of 8 cards) and with any winning symbol combinations being paid according to a predetermined paytable and preferably the same paytable as in the first game. Play continues as above as subsequent games are wagered upon and played. At any time if the outcome of any game is a non-winning outcome, the predetermined number of cards in the next game is the same as the predetermined number of cards in the first underlying game.

In a first preferred embodiment of the present invention, the player makes a wager to play a best-5-out-of-6-card video poker game. Six cards are initially dealt from a 52-card deck and displayed face up, and the player chooses to hold none, some, up to all of the displayed cards. Unheld cards are discarded, and replacement cards are provided for the discarded cards from the original deck minus the six dealt cards (i.e., a depleted deck of 46 cards). A final 6-card hand is formed by the total of the held cards and the replacement cards, and an outcome is determined by the final hand card symbols. The outcome is analyzed by the processor, with winning symbol combinations being determined by the best-5-out-of-6 cards. Winning symbol combinations are paid according to a predetermined paytable. If there are no winning symbol combinations, the player loses his wager and may choose to wager on a next 6-card game. If there is a winning symbol combination, the player may choose to make a wager (preferably the same wager as in the first underlying game) to play a second game featuring a bonus event. The bonus event increases the number of initially dealt cards to seven cards. The seven cards are initially dealt from a 52-card deck and displayed face up, and the player chooses to hold none, some, up to all of the displayed cards. Unheld cards are discarded, and replacement cards are provided for the discarded cards from the original deck minus the seven dealt cards (i.e., a depleted deck of 45 cards). A final 7-card hand is formed by the total of the held cards and the replacement cards, and an outcome is determined by the final hand card symbols. The outcome is analyzed by the processor, with winning symbol combinations being determined by the best-5-out-of-7 cards. Winning symbol combinations are paid according to a predetermined paytable, preferably the same paytable as utilized in the 6-card first game. If there are no winning symbol combinations, the player loses his wager and may choose to wager on a next 6-card game. If there is a winning symbol combination, the player may choose to make a wager (preferably the same wager as in the first underlying game) to play a third game featuring the bonus event that increases the number of initially dealt cards to seven cards. Play continues as described above, with the player playing a 6-card game after a non-winning outcome in the previous game, or a 7-card game after a winning outcome in the previous game.

In a second preferred embodiment of the present invention, the player makes a wager to play a best-5-out-of-6-card video poker game. Six cards are initially dealt from a 52-card deck and displayed face up, and the player chooses to hold none, some, up to all of the displayed cards. Unheld cards are discarded, and replacement cards are provided for the discarded cards from the original deck minus the six dealt cards (i.e., a depleted deck of 46 cards). A final 6-card hand is formed by the total of the held cards and the replacement cards, and an outcome is determined by the final hand card symbols. The outcome is analyzed by the processor, with winning symbol combinations being determined by the best-5-out-of-6 cards. Winning symbol combinations are paid according to a predetermined paytable. If there are no winning symbol combinations, the player loses his wager and may choose to wager on a next 6-card game. If there is a winning symbol combination, the player may choose to make a wager (preferably the same wager as in the first underlying game) to play a second game featuring a bonus event. The bonus event increases the number of initially dealt cards to seven cards. The seven cards are initially dealt from a 52-card deck and displayed face up, and the player chooses to hold none, some, up to all of the displayed cards. Unheld cards are discarded, and replacement cards are provided for the discarded cards from the original deck minus the seven dealt cards (i.e., a depleted deck of 45 cards). A final 7-card hand is formed by the total of the held cards and the replacement cards, and an outcome is determined by the final hand card symbols. The outcome is analyzed by the processor, with winning symbol combinations being determined by the best-5-out-of-7 cards. Winning symbol combinations are paid according to a predetermined paytable, preferably the same paytable as utilized in the 6-card first game. If there are no winning symbol combinations, the player loses his wager and may choose to wager on a next 6-card game. If there is a winning symbol combination, the player may choose to make a wager (preferably the same wager as in the first underlying game) to play a third game featuring a bonus event that increases the number of initially dealt cards to eight cards. The eight cards are initially dealt from a 52-card deck and displayed face up, and the player chooses to hold none, some, up to all of the displayed cards. Unheld cards are discarded, and replacement cards are provided for the discarded cards from the original deck minus the eight dealt cards (i.e., a depleted deck of 44 cards). A final 8-card hand is formed by the total of the held cards and the replacement cards, and an outcome is determined by the final hand card symbols. The outcome is analyzed by the processor, with winning symbol combinations being determined by the best-5-out-of-8 cards. Winning symbol combinations are paid according to a predetermined paytable, preferably the same paytable as utilized in the 6-card first game. If there are no winning symbol combinations, the player loses his wager and may choose to wager on a next 6-card game. If there is a winning symbol combination, the player may choose to make a wager (preferably the same wager as in the first underlying game) to play a fourth game featuring a bonus event that either (1) increases the number of initially dealt cards to nine cards to play a best-5-out-of-9-card game, or (2) keeps the number of initially dealt cards at eight to play another best-5-out-of-8-card game. In subsequent winning-outcome games, there may be a predetermined maximum number of initially dealt cards, in which case the number of initially dealt cards in the next game remains the same as in the present game (i.e., if the player receives a winning outcome when playing a best-5-out-of-9-card game, the next game will also be a best-5-out-of-9-card game).

An alternate method for the aforementioned embodiments of the present invention would provide a specific number of dealt cards in a subsequent game based on the specific winning symbol combination or hand rank in a present game. The provision of the bonus event itself is still based on obtaining any winning symbol combination, but the particular makeup of the bonus event may be determined by the winning hand rank. For instance, in a game with Three-of-a-Kind being the lowest rank, wins of Three-of-a-Kind, Straight, Flush or Full House may provide seven cards in the next game's initial dealt card array, while wins of Four-of-a-Kind, Straight Flush or Royal Flush may provide eight cards in the next game's initial dealt card array. As previously described, at any time if the outcome of any game is a non-winning outcome, the predetermined number of cards in the next game will be six.

In a separate method of the present invention, a bonus is still provided for every win, but the number of cards in the initial dealt array may be five cards. An additional side bet may be required to receive the bonus event opportunity. The various predetermined bonuses may be provided based on the specific winning symbol combinations or hand ranks. The provision of the bonus event itself is still based on obtaining any winning symbol combination, but the particular makeup of the bonus event may be determined by the winning hand rank. For instance, in a game with Three-of-a-Kind being the lowest rank, wins of Three-of-a-Kind may provide a free next hand, wins of Straight, Flush or Full House may provide a multiplier in the next wagered game, while wins of Four-of-a-Kind, Straight Flush or Royal Flush may provide a free game with a multiplier.

An alternative description of an embodiment of technology described herein includes a method of playing a video poker game. In the game, a player places at least a first wager on the video poker game to play a base draw poker game. A first displayed set of playing card symbols is displayed from a first complete set of playing cards. The player discards none, one, some or all of the cards in the player's hand to be held. The game replaces any discarded cards with replacement cards dealt from the remainder of the first complete set of playing cards to form a final player's hand. The final player's hand is analyzed to determine if a win is present according to a predetermined paytable. The player's at least one wager is resolved if a win is found. A bonus advantage is provided in a next wagered hand if any win is determined. The provision of the bonus advantage is not based on a particular criterium of the winning outcome, but rather is a guaranteed feature after any and all wins. The bonus advantage preferably is selected from the group consisting of at least one of an additional card in the first displayed set of playing card symbols, an enhanced payout paytable for at least some winning hands, and expansion of ranks that become winning hands, and the like. In a preferred play, the bonus advantage continues into all next hands as long as each consecutive round of play provides a winning hand. The minimum rank of a winning hand in the base game preferably consists of three-of-a-kind, a straight or a flush, and no hand with a lower rank wins in a player's final hand. The bonus advantage preferably comprises receiving more cards in next displayed sets of playing cards after a win in the player's final hand.

It is important to note that the use of minimum rank (especially a minimum rank above two pair, significantly alters both the paytables and the strategy for playing hands. For example, with a three-of-a-kind minimum win rank, two pair would be split, even though that rank is a win in most poker games (except for wild card games).

Reference to the Figures will assist in further understanding of the practice of the present invention, and in particular the practice of the first embodiment of the present invention.

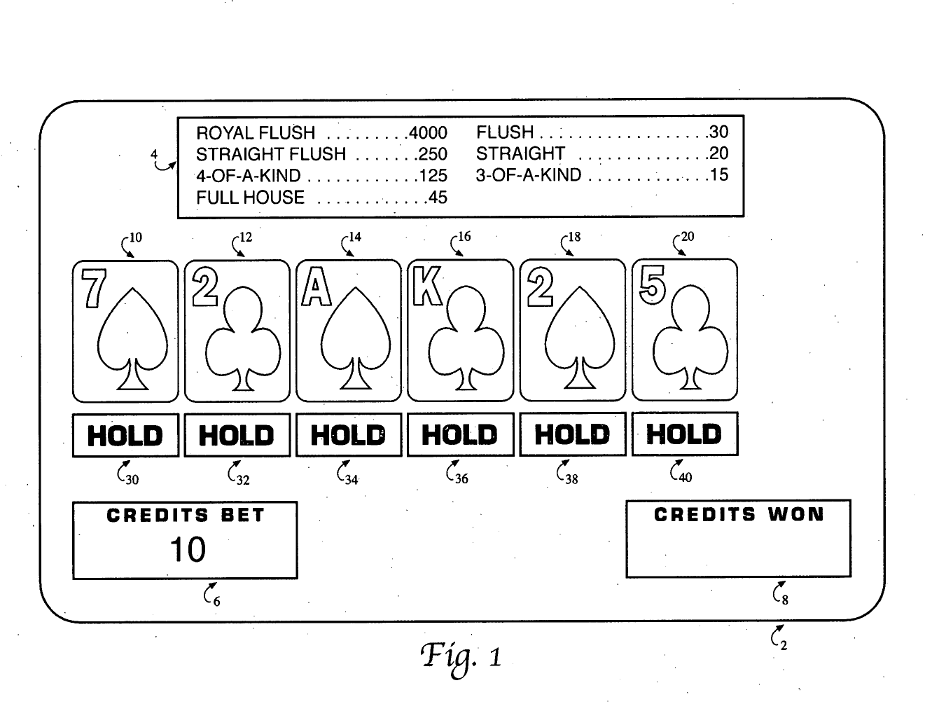

FIG. 1 shows a video poker machine monitor screen 2 with a boxed area for the paytable 4, a boxed area for the credits bet 6, and a boxed area for the credits won 8. The player has wagered 10 credits to play a first game that is the best-5-of-6 cards, and six individual cards (10, 12, 14, 16, 18, 20) have been dealt. Also shown are six HOLD buttons (30, 32, 34, 36,38, 40).

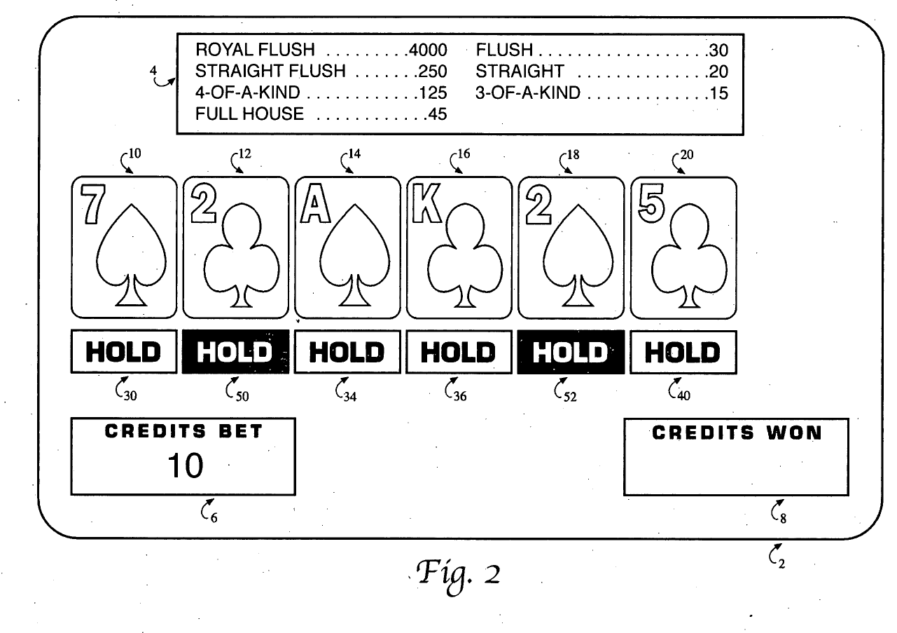

FIG. 2 refers to the game elements shown in FIG. 1 with the player electing to hold the two Deuces by pressing the HOLD button under the 2 of Clubs 50 and the HOLD button under the 2 of Spades 52.

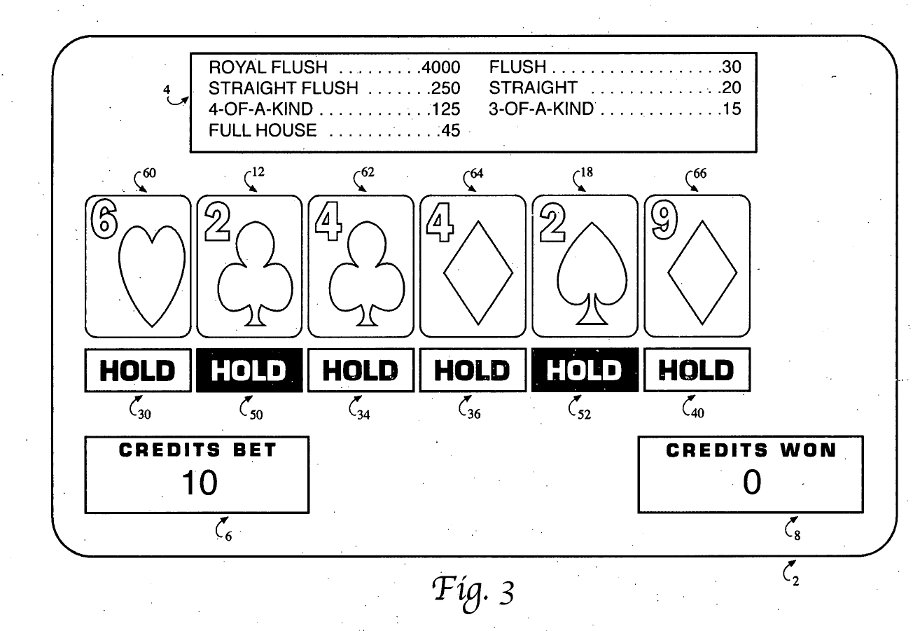

FIG. 3 refers to the game elements shown in FIG. 2 with draw cards (60, 62, 64, 66) shown that replace the unheld cards. The final result is Two Pair (2s and 4s), and is not a winning hand according to the paytable 4. The credits won 8 are shown as “0”. Since the player does not have a winning hand, the next hand will not be eligible for the bonus, which is one extra card in the hand.

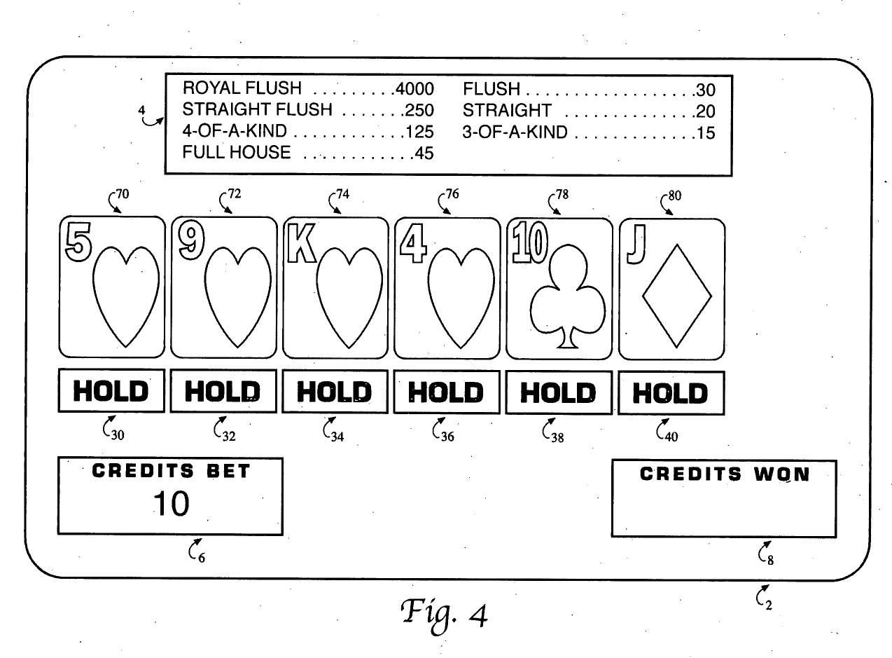

FIG. 4 refers to the game elements shown in FIG. 1, showing that the player has wagered 10 credits to play a second game that is the best-5-of-6 cards. Six new individual cards (70, 72, 74, 76, 78, 80) have been dealt.

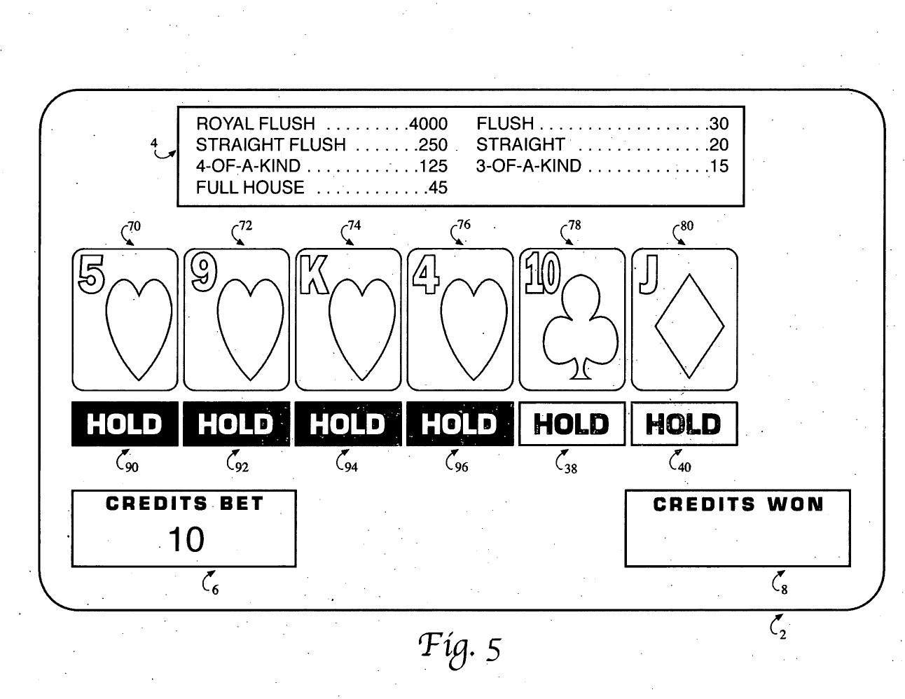

FIG. 5 refers to the game elements shown in FIG. 4 with the player electing to hold the four Hearts by pressing the HOLD button under the 5 of Hearts 90, the HOLD button under the 9 of Hearts 92, the HOLD button under the King of Hearts 94 and the HOLD button under the 4 of Hearts 96.

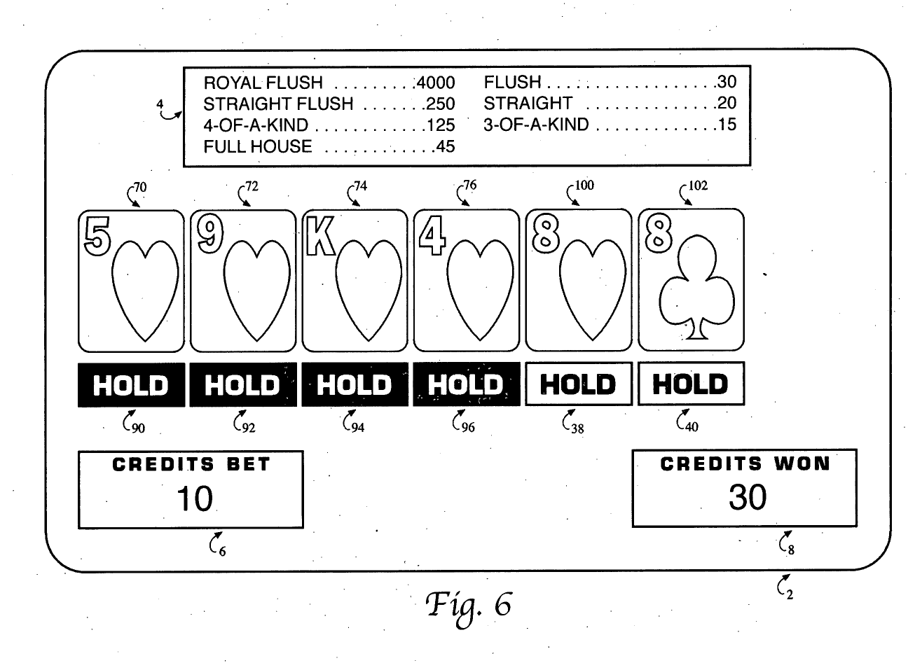

FIG. 6 refers to the game elements shown in FIG. 5 with draw cards (100, 102) shown that replace the unheld cards. The final result is a Flush, and is a winning hand according to the paytable 4. The credits won 8 are shown as “30”. Since the player has a winning hand, the next hand will be a bonus hand, having a seventh card in the hand for no extra fee.

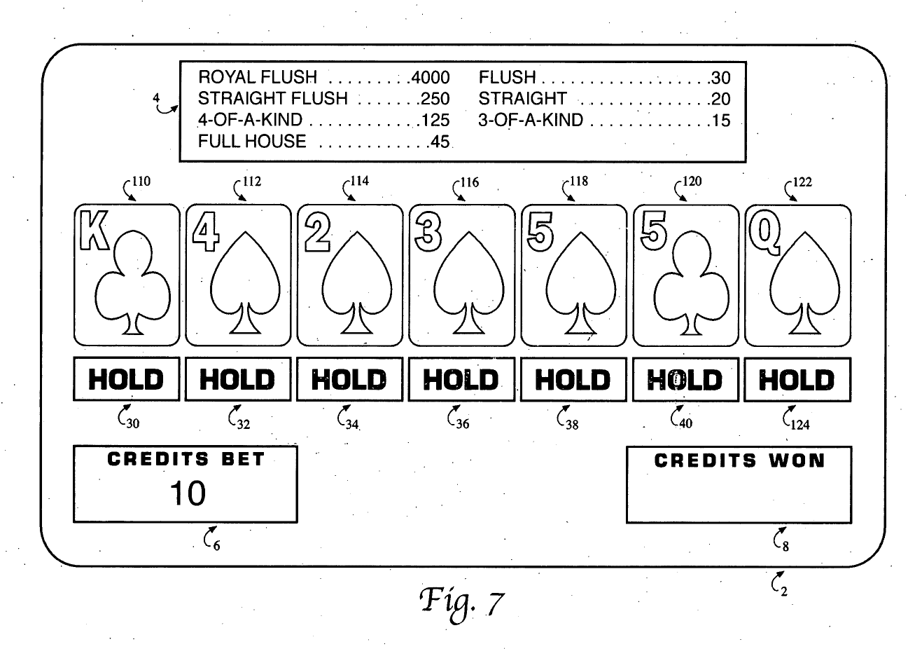

FIG. 7 refers to the game elements shown in FIG. 1, showing that the player has wagered 10 credits to play a third game that is the best-5-of-7 cards. Seven new individual cards (110, 112, 114, 116, 118, 120, 122) have been dealt, and one additional HOLD button 124 is shown under the seventh card.

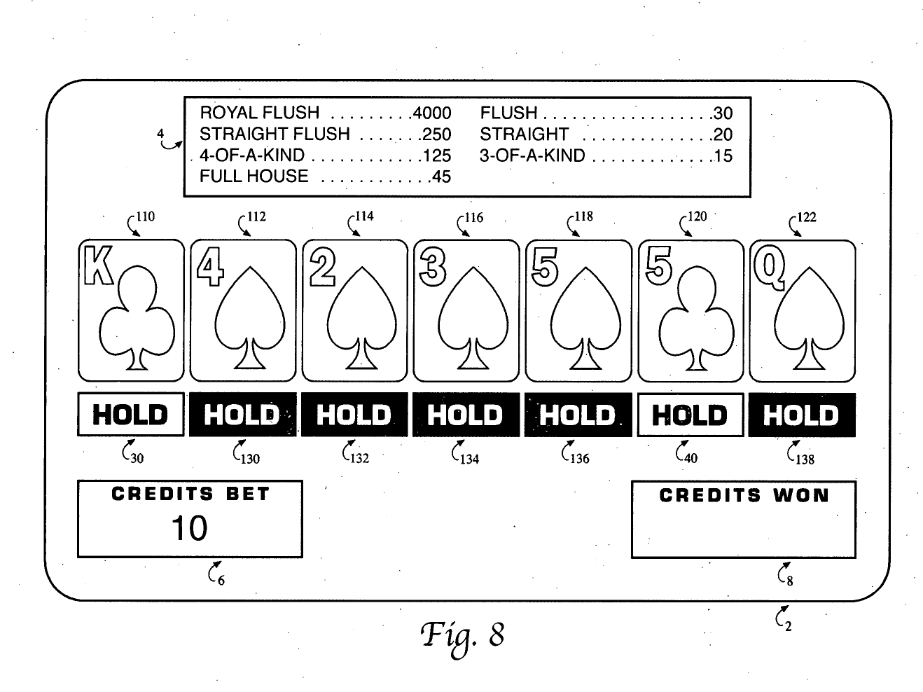

FIG. 8 refers to the game elements shown in FIG. 7 with the player electing to hold the five Spades by pressing the HOLD button under the 4 of Spades 130, the HOLD button under the 2 of Spades 132, the HOLD button under the 3 of Spades 134, the HOLD button under the 5 of Spades 136 and the HOLD button under the Queen of Spades 138. The player has a dealt Flush, but can possibly enrich that.

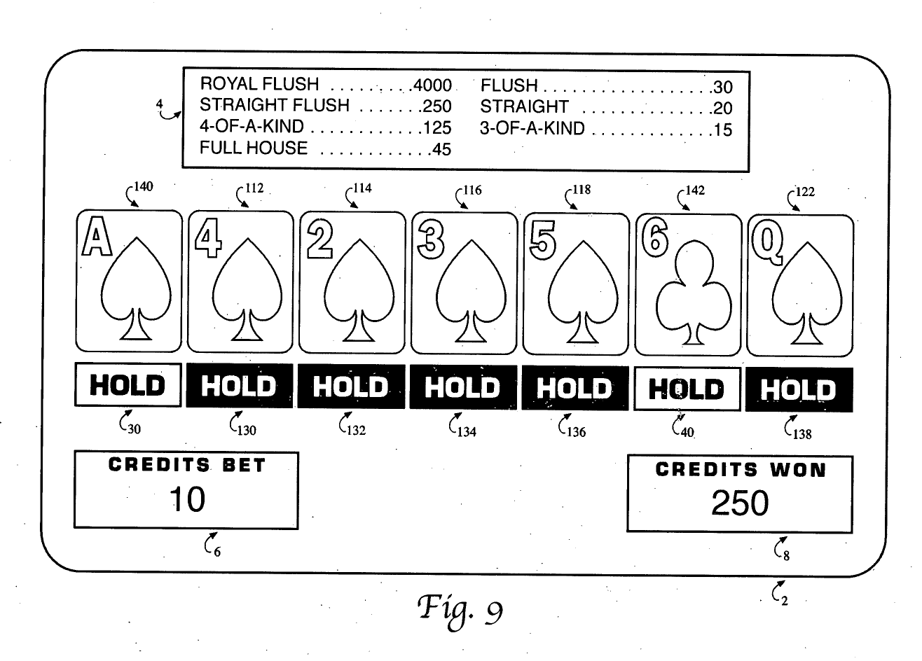

FIG. 9 refers to the game elements shown in FIG. 8 with draw cards (140, 142) shown that replace the unheld cards. The final result is a Straight Flush, and is a winning hand according to the paytable 4. The credits won 8 are shown as “250”. Since the player has a winning hand, the next hand will be a bonus hand, having a seventh card in the hand for no extra fee.

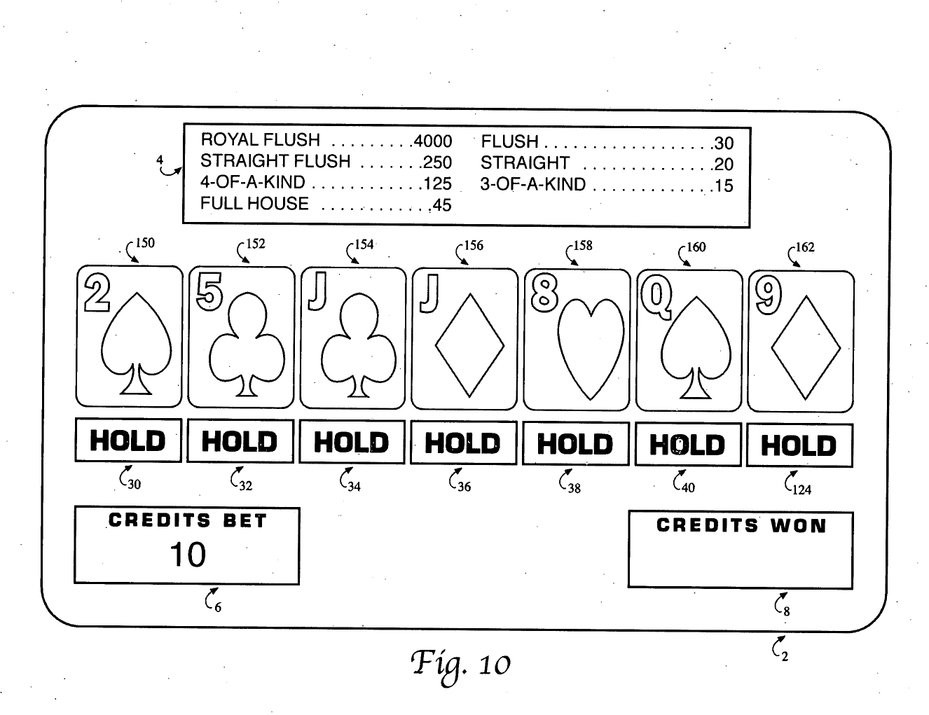

FIG. 10 refers to the game elements shown in FIG. 7, showing that the player has wagered 10 credits to play a fourth game that is the best-5-of-7 cards. Seven new individual cards (150, 152, 154, 156, 158, 160, 162) have been dealt.

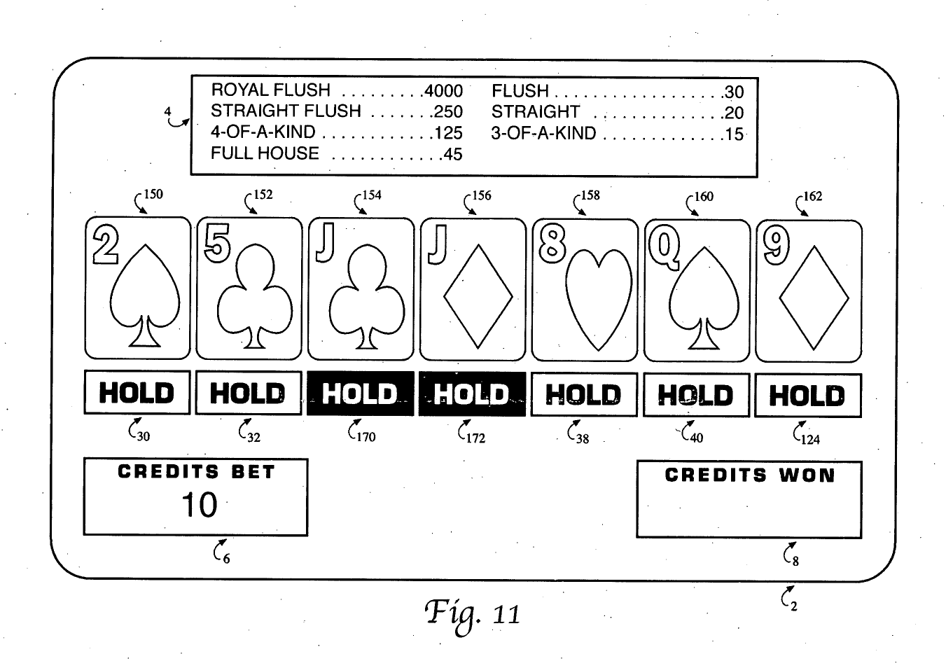

FIG. 11 refers to the game elements shown in FIG. 10 with the player electing to hold the two Jacks by pressing the HOLD button under the Jack of Clubs 170 and the HOLD button under the Jack of Diamonds 172.

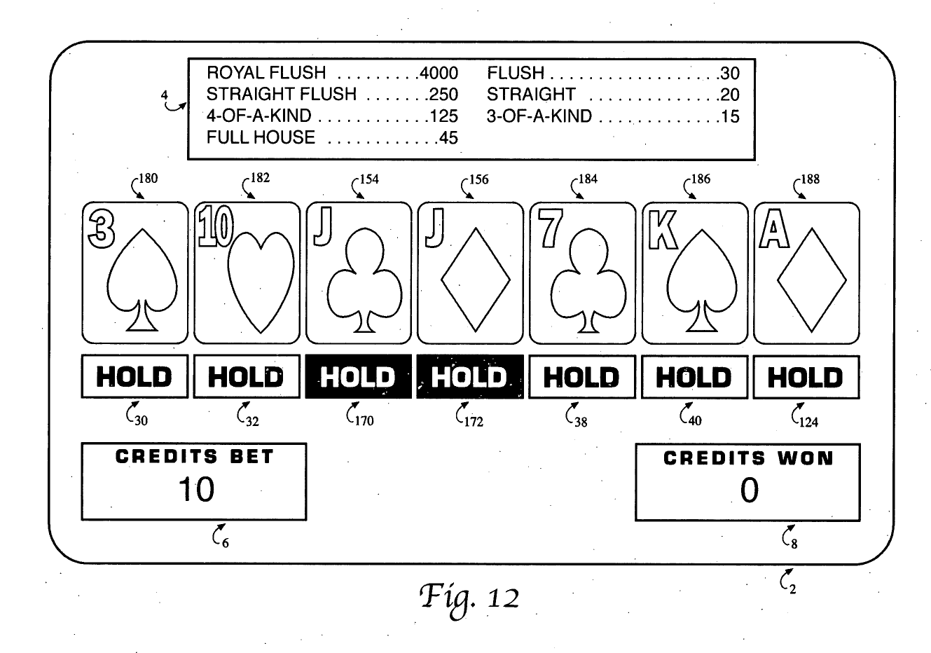

FIG. 12 refers to the game elements shown in FIG. 11 with draw cards (180, 182, 184, 186, 188) shown that replace the unheld cards. The final result is a Pair of Jacks, and is not a winning hand according to the paytable 4. The credits won 8 are shown as “0”. Since the player does not have a winning hand, the next hand will not be a bonus hand; instead, the next hand will revert back to the base game setup of 6 cards.

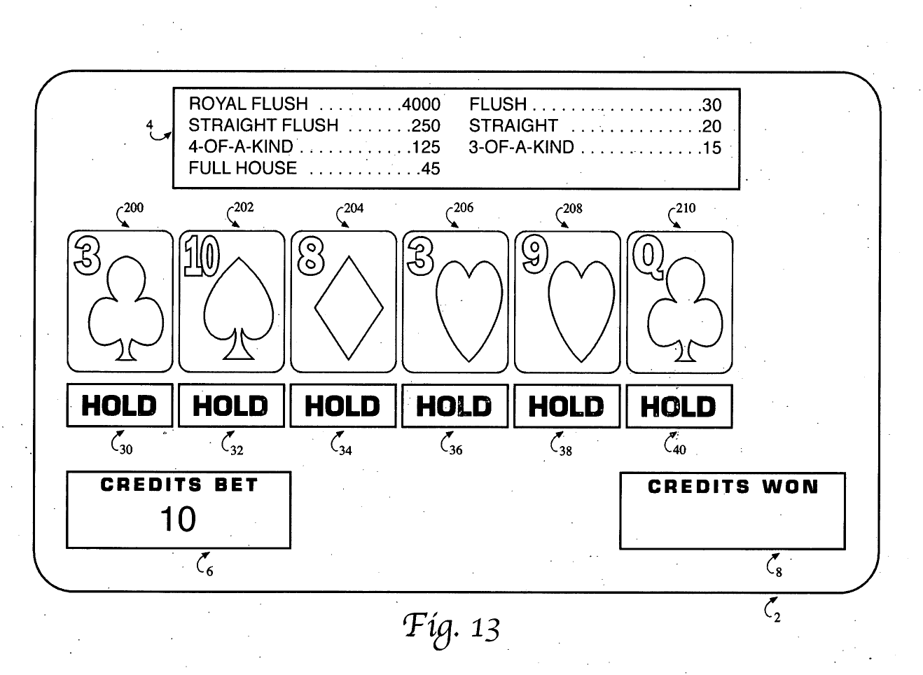

FIG. 13 refers to the game elements shown in FIG. 1, showing that the player has wagered 10 credits to play a fifth game that is the best-5-of-6 cards. Six new individual cards (200, 202, 204, 206, 208, 210) have been dealt. Play will continue according to the rules as described herein.

The various components of the gaming machine are controlled by a central processing unit (CPU), also referred to herein as a controller or processor (such as a microcontroller or microprocessor). To provide gaming functions, the controller executes one or more game programs stored in a computer readable storage medium, in the form of memory. The controller performs the random selection using a random number generator (RNG) of an outcome from the plurality of possible outcomes of the wagering game. Alternatively, the random event may be determined at a remote controller. The remote controller may either use an RNG or a pooling scheme for its central determination of a game outcome. It should be noted that the controller may include one or more microprocessors, including, but not limited to, a master processor, a slave processor, and a secondary or parallel processor.

The controller is also coupled to the system memory and a money/credit detector. The system memory may comprise a volatile memory (e.g., a random-access memory [RAM]) and a non-volatile memory (e.g., an EEPROM). The system memory may include multiple RAM and multiple program memories. The money/credit detector signals the processor that money and/or credits were input via the value input device. Preferably, these components are located within the housing of the gaming machine. However, as explained above, these components may be located outboard of the housing and connected to the remainder of the components of the gaming machine via a variety of different wired or wireless connection methods.

The controller is also connected to, and controls, the primary display, the player input device, and a payoff mechanism. The payoff mechanism is operable, in response to instructions from the controller, and awards a payoff to the player in response to certain winning outcomes that might occur in the basic game or the bonus game(s). The payoff may be provided in the form of points, bills, tickets, coupons, cards, etc. For example, the payoff mechanism may include both a ticket printer and a coin outlet. However, any of a variety of payoff mechanisms well known in the art may be implemented, including cards, coins, tickets, smartcards, cash, etc. One or more pay tables stored in the system memory determine the payoff amounts distributed by the payoff mechanism.

Communications between the controller and both the peripheral components of the gaming machine and external systems occur through input/output (I/O) circuits. More specifically, the controller directs and receives inputs from the peripheral components of the gaming machine through the input/output circuits. Further, the controller communicates with the external systems via the I/O circuits and a communication path (e.g., serial, parallel, IR, RC, 10bT, etc.). The external systems may include a gaming network, other gaming machines, a gaming server, communications hardware, or a variety of other interfaced systems or components. Even though the I/O circuits may be shown as a single block, it should be noted that each of the I/O circuits may include different types of I/O circuits.

Controller, as used herein, comprises any combination of hardware, software, and/or firmware that may be disposed or reside inside and/or outside the gaming machine that may communicate with and/or control the transfer of data between the gaming machine and a bus, another computer, processor, or device and/or a service and/or a network. The controller may comprise one or more controllers or processors. The controller may, alternatively, comprise a CPU in combination with other components, such as the I/O circuits and the system memory.

Although specific examples and specific images have been provided in this discussion, these specifics are intended to be only support for the generic concepts of the invention and are not intended to be absolute limits in the scope of the technology discussed.

What is claimed:

1. A method of playing a video poker game comprising:
a player placing a wager on the video poker game to play a base draw poker game;
displaying a first displayed set of playing card symbols from a first complete set of playing cards;
the player selecting none, one, some or all of the cards in the player's hand to be held;
discarding any cards from the player's hand that are not selected to be held;
replacing any discarded cards with replacement cards dealt from the remainder of the deck;
determining a final player's hand;
determining if the player's hand comprises a win according to a predetermined paytable;
resolving the player's wagers based on the determination; and
providing a bonus event opportunity in the next wagered hand if any win is determined.

2. The method of claim 1 wherein the first displayed set of playing cards comprises six cards.

3. The method of claim 1 wherein the determination of a win is based on a best-five-out-of-six cards.

4. The method of claim 1 wherein the wager remains the same regardless of the number of cards in the hand.

5. The method of claim 1 wherein the paytable remains the same regardless of the number of cards in the hand.

6. The method of claim 1 wherein the predetermined paytable starts at the minimum of three-of-a-kind.

7. The method of claim 1 wherein the provision of the bonus event is not based on a particular criterium of the winning outcome.

8. The method of claim 1 wherein the bonus event comprises the addition of at least one card to the number of cards in the first displayed set of playing card symbols.

9. The method of claim 8 wherein the bonus event comprises a fixed number of playing card symbols.

10. The method of claim 9 wherein there may be a maximum number of cards in a hand.

11. The method of claim 10 wherein the maximum number of cards is played until a loss.

12. The method of claim 8 wherein the bonus event is based on the hand ranking.

13. A method of playing a video poker game comprising:
a player placing a wager on the video poker game to play a base draw poker game;
displaying a first displayed set of playing card symbols from a first complete set of playing cards;
the player selecting none, one, some or all of the cards in the player's hand to be held;
discarding any cards from the player's hand that are not selected to be held;
replacing any discarded cards with replacement cards dealt from the remainder of the deck;
determining a final player's hand;
determining if the player's hand comprises a win according to a predetermined paytable;
resolving the player's wagers based on the determination; and
providing a bonus event opportunity in the next wagered hand if a win is determined.

14. The method of claim 13 wherein the first displayed set of playing cards comprises five cards.

15. The method of claim 13 wherein the determination of a win is based on a best-5-out-of-5 cards.

16. The method of claim 13 where the provision of the bonus event is not based on a particular criterium of the winning outcome.

17. The method of claim 13 wherein the bonus event comprises at least one of the following in the next wagered hand: free hands, multipliers, wild cards, expanded paytables, higher paytables.

18. The method of claim 13 wherein the bonus event may be based on the hand ranking, or an additional wager may be required to qualify for the bonus event opportunity.

19. A method of playing a video poker game comprising:
a player placing a wager on the video poker game to play a base draw poker game;
displaying a first displayed set of playing card symbols from a first complete set of playing cards;
the player discarding none, one, some or all of the cards in the player's hand to be held;
replacing any discarded cards with replacement cards dealt from the remainder of the first complete set of playing cards to form a final player's hand;
determining if the final player's hand comprises a win according to a predetermined paytable;
resolving the player's wagers based on the determination; and
providing a bonus advantage in a next wagered hand if any win is determined.

20. The method of claim 19 wherein the bonus advantage is selected from the group consisting of at least one of an additional card in the first displayed set of playing card symbols, an enhanced payout paytable for at least some winning hands, an expansion of ranks that become winning hands, and the like.

21. The method of claim 20 wherein the bonus advantage continues into all next hands as long as each consecutive round of play provides a winning hand.

22. The method of claim 21 wherein the bonus advantage is provided for any winning hand regardless of the rank of the winning hand.

23. The method of claim 22 wherein a minimum winning hand in the base game consists of three-of-a-kind, a straight or a flush.

24. The method of claim 23 wherein the bonus advantage comprises receiving more cards in next displayed sets of playing cards after a win in the player's final hand.
